(19) United States
(12) Patent Application Publication
(10) Pub. No.: US 2026/0092597 A1
(43) Pub. Date: Apr. 2, 2026

(54) Separator-Based Motion System for Cyclical Energy Release

(71) Applicant: Nathan Kress, Sarasota, FL (US)

(72) Inventor: Nathan Kress, Sarasota, FL (US)

(21) Appl. No.: 19/334,979

(22) Filed: Sep. 22, 2025

Related U.S. Application Data
(60) Provisional application No. 63/701,700, filed on Oct. 1, 2024.

(51) Int. Cl. F03G 3/00; F03G 7/10

(52) U.S. Cl. CPC F03G 3/094; F03G 7/10

(57) ABSTRACT

A mechanical system for generating controlled, repeatable motion by selectively releasing stored energy using a movable separator. The apparatus includes a base-mounted structure supporting a vertically or horizontally sliding platform, a force-generating element such as a spring or repelling magnet assembly, and a separator positioned between the force source and the moving object. When the separator is in place, it prevents energy transfer; when withdrawn, it allows a rapid release of energy, propelling the platform. The separator may be actuated mechanically or electronically, with timing and unlocking triggered by internal system motion or external controllers. Variants include top-mounted springs or magnets to increase compression, magnetic configurations to eliminate contact and reduce wear, and optional locking and braking mechanisms for precision control. The system operates without combustion, may function in gravity or zero-gravity environments, and supports both power generation and mechanical actuation across diverse applications.

### CROSS-REFERENCE TO RELATED APPLICATIONS

This application claims the benefit of U.S. Provisional Application No. 63/701,700, filed on Oct. 1, 2024, entitled “Machine That Generates Motion With A Spring And A Lock.” The entire disclosure of the referenced application is hereby incorporated by reference.

### FIELD OF INVENTION

The present invention relates generally to mechanical motion systems, and more particularly to an apparatus and method for storing and selectively releasing energy using a spring or repelling magnetic element in combination with a movable separator that governs the timing of force transfer to a moving platform. The invention provides precise control over cyclical mechanical motion and is adaptable for both gravity-assisted and zero-gravity environments.

### BACKGROUND

In the field of mechanical energy systems, various devices have been developed to capture and release stored energy for the purpose of generating motion. Traditional systems often rely on springs, gravity, hydraulic actuators, or magnets to provide force, and use timing mechanisms or control systems to regulate movement. However, such systems tend to be either continuously active or limited by imprecise triggering of energy transfer, resulting in inefficient operation, excessive wear, or limited controllability.

Conventional spring-powered mechanisms, for instance, typically transfer force as soon as the spring is compressed, making it difficult to control the exact moment of energy release. In applications where precision, repeatability, or energy efficiency is critical, this uncontrolled behavior can reduce effectiveness and limit utility. Similarly, magnetic repulsion systems have been used in motion-generating devices, but their timing mechanisms are often electronically dependent or lack modular adaptability.

Moreover, many motion systems in the prior art rely heavily on continuous external energy input, sophisticated electronics, or complex actuation mechanisms that reduce reliability and increase manufacturing cost. In some cases, designs fail to address how stored mechanical energy can be released in a delayed or staged fashion—especially without electronics—or how to trigger force transfer only when optimal mechanical alignment or system pressure is achieved.

There remains a need for a simple, robust, and controllable motion-generating apparatus that uses stored energy efficiently and allows force to be selectively released through a repeatable and modular mechanism. A system that can operate using gravity, springs, or repelling magnetic fields, with mechanical or electronic control over motion timing, would represent a significant advancement in the field. Such a system would ideally offer improved efficiency, minimal part wear, broad configurability, and operational flexibility in both terrestrial and non-terrestrial environments.

The present invention addresses these long-standing limitations by introducing a novel energy transfer control system in the form of a movable separator, enabling precise force release and repeatable actuation using a wide range of configurations.

### SUMMARY OF THE INVENTION

The present invention provides a mechanical energy release system featuring a movable separator that controls the precise transfer of force between a stored-energy element and a moving platform. The apparatus includes a base-mounted pole or guide structure along which a vertically or horizontally movable platform travels. A spring, pair of repelling magnets, or other force-generating component is positioned beneath or opposite the platform. A separator is interposed between the platform and the stored-energy component, preventing force transfer until selectively retracted.

Upon compression of the spring or magnetic repulsion system—by gravity, an additional top-mounted force, or external pressure—the separator temporarily isolates the moving object from the stored energy. At a selected moment, the separator is withdrawn mechanically or electronically, allowing the energy to transfer rapidly and propel the platform. In some embodiments, locking mechanisms and friction components regulate motion, improve timing, and minimize unwanted rebound. Other versions utilize repelling magnets to achieve contactless energy transfer, reducing mechanical wear and enabling operation in contamination-sensitive environments.

The system may be constructed with no electronics, relying solely on mechanical linkages, or with electronic controllers and actuators. It may operate vertically or horizontally and support multi-unit configurations for increased force output or parallel operation. The invention enables repeated, controlled motion cycles using internally stored energy, offering a reliable, fuel-free solution for power generation, motion control, or energy transfer applications.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a side view of the apparatus configured without an upper spring, showing the separator in the retracted (non-blocking) position and using a dual-pole support system with an independently locked bottom spring.

FIG. 2 is a side view of the apparatus configured similarly to FIG. 1 but with the separator shown in the engaged (blocking) position, illustrating how the spring is temporarily prevented from pushing against the moving object.

FIG. 3 is a side view of the apparatus including a top-mounted mechanical spring pressing downward onto the moving object, showing a single central motion-guiding pole and roof-supported compression structure.

FIG. 4 is a side view of the apparatus configured with upper and lower repelling permanent magnets instead of mechanical springs, incorporating three separate support poles and a separator positioned between the magnet and the moving object.

### DETAILED DESCRIPTION OF THE DRAWINGS

The accompanying drawings illustrate embodiments of the invention and, together with the detailed description, serve to explain the principles of the invention.

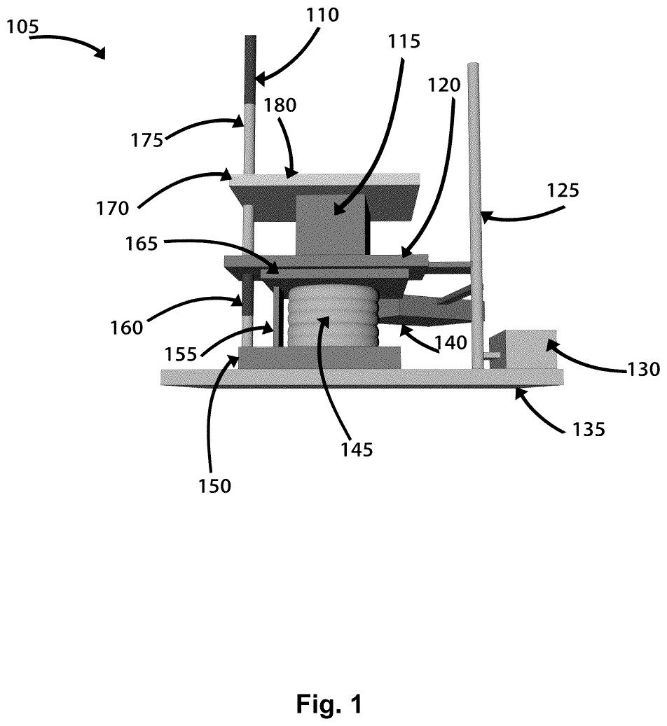

FIG. 1 illustrates an embodiment of the invention in which the system operates using gravity alone, without any upper spring element applying additional downward force. The machine 105 serves as the primary housing, mounted upon a base 135. A heavy weight 115 is sandwiched between an upper surface 170 and a lower surface 120, together forming the moving object. The lower surface 120 is directly connected to a right-side locking and unlocking pole 125, which slides along a guided track and allows vertical motion. This right pole also supports the separator 140, which is depicted in the rotated-out position. In this position, the separator no longer obstructs upward motion from the spring 145, which is situated directly below the moving object. The top of the spring 165 is free to collide with the underside of the lower moving surface 120 when the separator is retracted.

The spring 145 is anchored at its lower end by a fixed base 150 and may be held in a compressed state by a locking mechanism 155. A friction brake pad 110 is installed at the top of the pole to reduce bounce during upward movement, while a second brake pad 160 is located near the base of the left-side motion pole 175, which is rigidly attached to both the upper and lower surfaces of the moving object. This left pole serves solely as a guide for the vertical travel of the object and ensures linear alignment. The external controller 130 is connected to the right-side unlocking pole 125 and may be used to rotate the separator 140 in or out of position, depending on control logic or timing. The spring 145 is allowed to expand only when the separator is no longer obstructing the space beneath the moving object, thereby initiating a powerful upward motion.

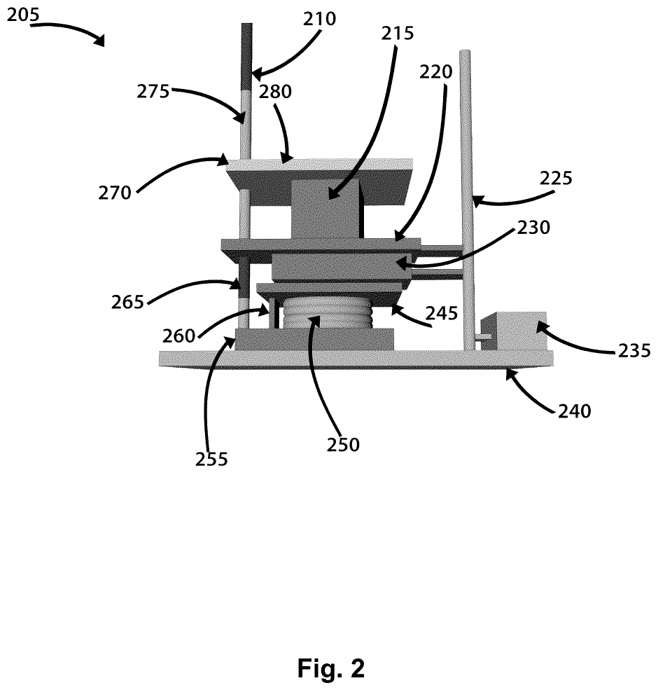

FIG. 2 presents a similar configuration to FIG. 1, but in this embodiment, the separator 230 is shown in the blocking position, occupying the space between the compressed spring 250 and the lower surface 220 of the moving object. The machine 205 rests on a base 240, and the weight 215 remains suspended between an upper portion 280 and a lower portion 220, which is attached to a right-side unlocking pole 225. This pole travels along a track, providing motion while supporting the separator 230. The separator in this version obstructs the spring from expanding upward, thereby locking the potential energy of the spring 250, which is supported at its bottom by fixed base 255 and restrained by locking mechanism 260.

Braking pads 210 and 265 are used at the top and bottom of the motion path to manage impact and rebound forces. The left pole 275 serves as the primary guide structure for the vertical movement of the platform. The spring's upper plate 245 is positioned to collide with the lower moving surface 220 only when the separator 230 is withdrawn. The external power controller 235 connects to the unlocking pole and potentially manages the activation of the separator and locking mechanism. This version demonstrates how the invention functions using gravitational compression of the spring and a space-occupying separator to regulate when force is transferred to the moving platform.

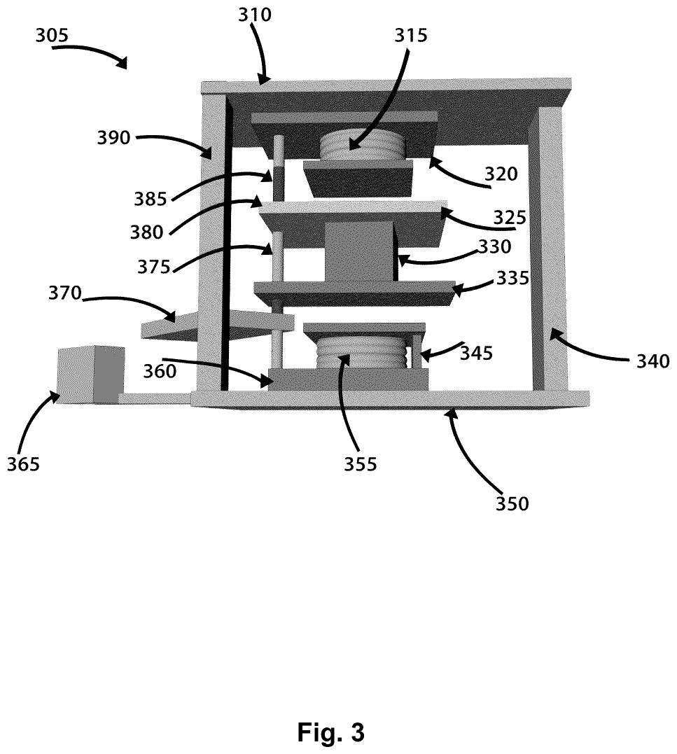

FIG. 3 illustrates a version of the invention that utilizes a top-mounted spring 315 to apply additional downward force. The top spring is housed beneath a roof structure 310 supported by pillars 340 and 390 that are affixed to the base 350. The spring 315 rests beneath this roof and exerts force on the top of the moving object, which consists of an upper surface 325, a central weight 330, and a lower surface 335. The lower surface 335 is directly connected to the motion pole 375, which provides the linear travel path.

A second spring 355 is located beneath the moving object, anchored at the base 360. A separator 370 is positioned between this lower spring and the moving object and can be retracted as needed. Braking friction pads 385 are used at the top of the motion path to reduce shock. The external power supply 365 is wired to multiple components including the separator and locking mechanisms 345. The upward force of the lower spring is only allowed to act on the moving object when the separator is removed from the space it occupies. This embodiment shows the capability of using a downward-facing spring, supported by an upper housing, to supplement the compression of the lower spring and enhance the total energy stored in the system.

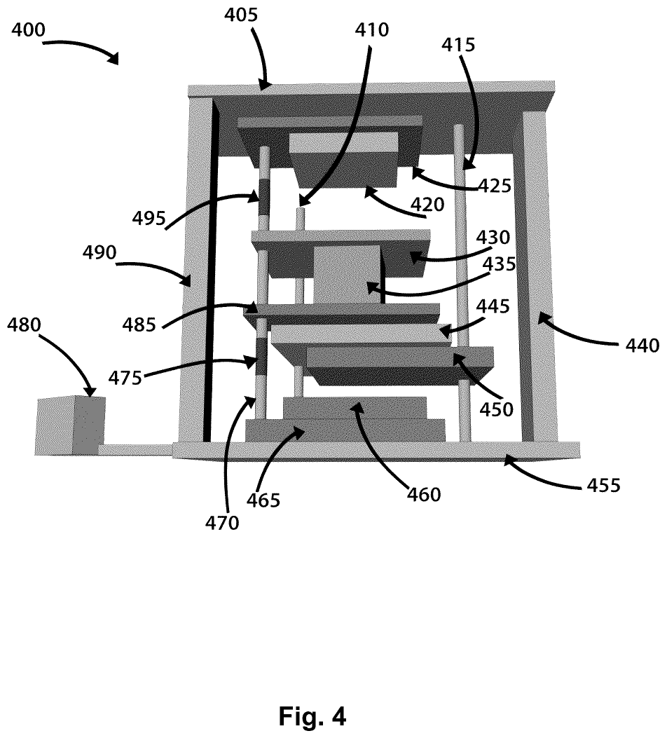

FIG. 4 demonstrates a configuration that replaces mechanical springs with repelling magnets. This embodiment includes three separate poles: a rear support pole 410, a right-side pole 415 connected to the upper repelling magnet 420, and a sliding pole 470 connected to the moving object. The roof 405 supports the upper magnet 420, which is held in place by magnet base 425. This magnet repels the lower magnet 450, which is located beneath the moving object and interacts with a fixed magnet 460 anchored into the base 455 via base plate 465.

The moving object includes an upper surface 430, a weight 435, and a lower surface 485, all sliding along pole 470. A separator 445 is positioned between the repelling magnets and the moving object and functions identically to previous embodiments. The separator can block or allow motion from the repelling magnets to the moving platform. Friction brake pads 495 and 475 are installed at the top and bottom travel limits. Electrical wiring from external power unit 480 connects to various components to control their operation. Support structures 440 and 490 secure the roof assembly. This embodiment demonstrates how the spring force in the invention may be replaced by permanent or electromagnetic repulsion systems to achieve the same cyclical energy release effect.

Each figure collectively demonstrates the flexibility of the invention's core principle: the controlled release of stored energy through a separator mechanism that selectively allows force transfer to a moving object. Whether by gravity, spring, or magnetic force, and whether the separator is mechanical or electronically controlled, the essential motion cycle remains consistent across these embodiments.

### DETAILED DESCRIPTION

This invention is made up of a simple, clear setup. There is a base, and from that base, a pole extends vertically. A platform, or moving object, slides up and down along this pole. Beneath this moving platform is a spring or a similar force-generating element, such as a pair of repelling magnets. Between the spring and the moving platform is a small part called the separator. The separator can move in and out of the space between the spring and the moving platform. These parts all stay aligned with each other on the pole, and they move along a track that keeps them steady. That is the basic setup of the invention.

The main function of the invention starts when the moving platform is pushed downward and compresses the spring, with the separator in between. The separator acts as a blocker, stopping the spring from directly touching and pushing the moving platform. Once the spring is fully compressed, the separator is quickly moved out of the way. This allows the spring to suddenly expand and push against the bottom of the platform, launching it upward. The separator makes sure this happens at just the right moment. Without the separator, the spring would just slowly push on the platform or not build up enough force. The whole invention is designed so the stored energy in the spring is only released when the separator is removed, which creates a powerful and controlled motion. The separator can be moved either electronically or mechanically. In the electronic version, a computer or sensor triggers the separator to rotate or slide out using an electromagnet or similar device. In the mechanical version, no electronics are needed. Instead, a mechanical locking system responds to changes in pressure or position and releases the separator at the right moment. The separator always stays just under the platform and follows it as it moves up and down.

The invention is designed so that the movement of the separator or any locking mechanisms does not require any continuous external input. The unlocking or shifting of the separator can be powered purely by the energy previously stored in the system itself during earlier cycles of operation. In this way, the invention becomes capable of repeating its motion cycle using the energy generated from its own prior movement. In some cases, small amounts of external energy may be used to trigger unlocking actions, but the amount required is always less than the energy output of the system when it drives the moving object up and down. This allows the invention to be extremely efficient and potentially self-sustaining in operation. The speed at which the system operates can be adjusted. If the unlocking or separator shifting mechanisms are tuned for rapid activation, the motion cycle can repeat quickly and the moving platform can travel up and down many times per second. If slower motion is desired, the unlocking can be timed to longer intervals. The size of the pole and the strength of the forces involved, such as spring strength or magnet repulsion, also influence the speed and range of movement.

In the mechanical version of the system, the energy needed to unlock the separator or any locking mechanism can be derived from the motion of the platform itself. As the platform descends and compresses the spring, part of its motion can be mechanically coupled to a triggering arm, cam, ratchet, or force-sensitive linkage that stores a small portion of kinetic or spring energy in a latch, tension member, or rotational pre-load. Once the platform reaches a designated position-such as maximum compression-a release mechanism is triggered either through contact, over-compression, or alignment with a trip feature. This release may rotate or slide the separator out of position with precise timing, enabling the spring to expand. In other implementations, the separator may be biased by a spring or magnetic element into its release position and held back by a latch that is disengaged through contact with the platform or spring at a critical point in the cycle. These configurations allow the unlocking and separator movement to occur automatically, cycle after cycle, without the need for external control inputs or sustained electrical power.

The invention further includes all functionally equivalent mechanical implementations capable of performing the unlocking, timing, or energy redirection required for operation of the separator or locking mechanisms. This includes, but is not limited to, any mechanical trip release, delay arm, cam profile, weighted lever, spring latch, ratcheting mechanism, magnetic detent, or inertial trigger that derives its timing or actuation from the prior motion or stored energy of the platform or spring. Any configuration that uses the motion, force, or position of the platform or spring to activate the separator—whether through direct contact, transmission through a linkage, or stored preloaded energy—is encompassed within the scope of this invention. The invention is not limited to the particular mechanical structures explicitly shown or described, but also includes all mechanical systems that accomplish the same timing, unlocking, and energy transfer behavior.

One version of the invention works by using gravity only. There is no top spring or magnetic force pushing the platform downward. The platform simply has weight, and gravity pulls it downward, compressing the spring beneath it while the separator is in between. Once the platform reaches the lowest point and the spring is compressed, the separator is quickly moved out of the way. This lets the spring expand and push the platform back up. This version uses only the weight of the platform to function. It is straightforward and works best where gravity is available. The electronic or mechanical separator described above can be used in this version.

Another version adds a second force element above the platform. This can be a spring or a pair of repelling magnets that are mounted to the pole above the platform. This top-mounted spring or magnet assembly pushes the platform downward, adding more force to compress the spring below. With more compression, the spring stores more energy. As before, the separator blocks the spring from acting until it is removed. When the separator is taken out of the way, the spring expands and pushes the platform up with greater force. This version is useful in environments with low gravity or when more motion is needed. It can be combined with the separator types and gravity-only design.

Another version uses a locking system to hold the platform, the spring, or the separator in place at the point of maximum compression. This lock keeps everything still for a moment. Then, after a short delay, the lock is released at the same time the separator is moved out of the way. This causes the spring to release its energy all at once, sending the platform upward in a single, strong motion. The locks are especially helpful for preventing bouncing or unwanted movement and make the motion more precise. This version can be added to both the gravity-only setup and the top-force version.

Another version includes parts that control motion using friction or guiding systems. These may include brake pads or friction pads on the pole to slow the platform as it moves downward. This reduces impact and helps prevent bounce. In other designs, a locking device stops the platform at the lowest point before the spring is released. There may also be a guide track that only allows movement in one direction. For example, the track might allow downward motion but prevent upward motion until the separator is removed. These features make the system smoother, quieter, and more controlled. They can be included in any version of the invention.

Another version changes the layout of the system from vertical to horizontal. Instead of moving up and down, the platform moves side to side along a horizontal pole. The spring or magnets still compress and release energy, and the separator still blocks and allows motion in the same way. This horizontal setup works in zero-gravity environments or in outer space, where gravity cannot help compress the spring. The top-mounted spring or magnets from the earlier version can still be used to push the platform into the spring. The other parts of the system, like the separator and locking mechanisms, can be the same as in the vertical version. In the horizontal version, it is important that the platform is able to travel far enough across the length of the pole to fully compress the spring or magnetic system on the opposite side. The design must ensure that the spring reaches a level of compression strong enough to trigger the separator mechanism properly. Without sufficient compression distance and force, the spring would not have enough stored energy to activate the separator or drive the platform back in the opposite direction with the intended power. Therefore, the pole must be long enough and the movement unobstructed to guarantee the spring or magnets are engaged with enough intensity to operate the system in a repeated cycle, just as in the vertical version.

Another version includes more than one unit working together. Each unit has its own base, spring, separator, and platform. These units can be mounted side-by-side or in a connected frame. Each one can operate at the same time or in a timed sequence. In some designs, a guide rod or second pole may be added to help control the motion of the spring. Other versions remove the lower part of the pole completely and use a locking device instead. This setup allows for greater total motion or force output. All the other versions of the invention can be applied to each unit in the multi-unit system. For example, one unit may use top magnets, another may use gravity only, and both may use friction or locking systems.

In another version of the invention, the spring, separator, and moving object are configured to interact solely through magnetic fields, thereby eliminating direct mechanical contact between these components. In this implementation, repelling magnets—either permanent magnets or electromagnets—are attached to both the top and bottom surfaces of the components involved in the interaction. For example, the bottom of the moving object may carry a magnet that repels a corresponding magnet located at the top of the separator. Similarly, the bottom surface of the separator may include a magnet that repels a magnet positioned on the upper surface of the spring or spring platform. In cases where a component is not positioned above or below another (such as the bottom of the spring or the top of the moving object), a magnet is not required on that end. This configuration also allows the separator to remove itself more easily during operation, as it is not in direct contact with the spring surface below or the moving object above, thereby eliminating friction and resistance from those surfaces.

These magnet pairs are oriented to repel one another, creating virtual contact zones where force is transferred without physical collision. As a result, the motion of the platform, the timing of the separator, and the release of energy from the spring or equivalent force-generating element can all be achieved with high precision while minimizing wear, vibration, and mechanical fatigue. The use of non-contact repelling forces preserves the same timing and functionality as previous configurations while enabling cleaner, quieter, and longer-lasting operation.

This magnetically-coupled configuration may be implemented in any of the previously described embodiments, including vertical, horizontal, and multi-unit setups, and is particularly advantageous in environments where contamination, mechanical wear, or impact-induced degradation must be avoided, mechanical wear, or impact-induced degradation must be avoided.

In some implementations, the invention may utilize two or more separate poles to support and guide one or more moving platforms, allowing for additional stability, parallel motion paths, or alternative mechanical arrangements. Additionally, the spring may be mounted to a dedicated guide structure in the form of an expandable and contractible pole that is positioned beneath the upper surface of the spring. This guiding pole does not protrude into the space above the spring and serves only to maintain the spring's axial alignment during compression and expansion. In certain configurations, this spring-guiding pole may also incorporate a locking mechanism capable of restraining or releasing the spring at selected points in the motion cycle.

This invention does not burn fuel. It is a mechanical system that uses stored energy in a spring or magnets and releases that energy at the right moment using a special movable separator. The system can be built with no electronics at all or can use sensors and actuators. It can be used in places with gravity or in zero-gravity. It is designed to be flexible, simple, and reliable, offering controlled, repeated motion for a wide range of possible uses.

This disclosure is intended to encompass all variations, modifications, and equivalents of the invention described herein that fall within the scope of the appended claims. The embodiments and versions disclosed represent the best modes currently contemplated, but it is understood that other arrangements, substitutions, or combinations of components and features may be employed without departing from the inventive concept. The invention covers all implementations that achieve the same or equivalent function, structure, or result, whether or not every such embodiment is specifically illustrated or described in detail.

1. A mechanical energy system, comprising:
a base;
a pole extending from the base;
a moving object configured to travel along the pole, the moving object having sufficient mass to generate compressive force under gravity alone;
a force-generating element disposed beneath the moving object;
a movable separator positioned between the moving object and the force-generating element; and
an output linkage mechanically connected to the moving object and configured to convert its motion into mechanical work, rotational movement, or electrical energy;
wherein the separator is configured to temporarily prevent force transfer from the force-generating element to the moving object, and to permit release of stored energy upon actuation.

2. The system of claim 1, wherein the force-generating element comprises a spring, one or more repelling magnets, or a combination thereof.

3. The system of claim 1, wherein the output linkage comprises a crankshaft, alternator shaft, gear train, or hydraulic transmission system.

4. The system of claim 1, wherein the separator is configured to be removed or shifted using energy stored from a previous motion cycle.

5. The system of claim 1, further comprising a locking mechanism configured to secure the separator, the moving object, or the force-generating element in position until a trigger event occurs.

6. The system of claim 1, wherein the separator, force-generating element, and moving object are magnetically repelled from one another, thereby eliminating physical contact during operation.

7. The system of claim 6, wherein the repelling magnetic elements comprise permanent magnets, electromagnets, or combinations thereof.

8. The system of claim 1, further comprising a second object disposed above the moving object and configured to exert downward force via gravity, spring compression, or magnetic repulsion.

9. The system of claim 1, wherein the pole is oriented horizontally, the moving object is configured to move laterally without gravitational assistance, and the motion is driven by a force-generating element comprising a mechanical spring or a pair of repelling magnets configured to propel the object far enough to compress an opposing force-generating element on the opposite side.

10. The system of claim 1, wherein the separator is mechanically biased toward a retracted position and held in place by a trip-release, latch, or motion-triggered contact mechanism.

11. The system of claim 1, further comprising a guiding pole extending beneath the force-generating element, configured to maintain its alignment during compression and expansion without protruding above the element.

12. The system of claim 1, further comprising a braking or damping mechanism configured to reduce bounce or vibration during motion of the moving object.

13. The system of claim 1, wherein the separator is electronically or mechanically actuated via a sensor, control circuit, or mechanical trigger.

14. The system of claim 1, wherein the moving object comprises a mass enclosed between upper and lower support plates connected to one or more travel-guiding poles.

15. The system of claim 1, further comprising a plurality of motion units arranged in parallel or series, each having its own base, pole, moving object, force-generating element, and separator.

16. A mechanical motion system, comprising:
a base;
a plurality of poles extending from the base;
a moving platform configured to travel along the poles;
a lower force-generating element positioned to apply upward force to the moving platform;
an upper force-generating element configured to apply downward force to the moving platform;
a separator positioned between the lower force-generating element and the moving platform; and
an energy extraction mechanism connected to the moving platform and configured to generate rotational or electrical output;
wherein the separator temporarily blocks force transfer from the lower force-generating element, and releases stored energy when removed.

17. The system of claim 16, wherein the upper and lower force-generating elements each comprise springs, repelling magnets, or combinations thereof.

18. A method for generating and repeating mechanical or electrical energy cycles, comprising:
positioning a moving object along a pole with a force-generating element beneath or behind it and a movable separator between them, the moving object comprising either an integrated weight or a propulsion source configured to move the object in the absence of gravity;
permitting the moving object to descend or traverse under gravitational, spring-based, or magnetic repelling force;
blocking force transfer from the force-generating element using the separator;
compressing the force-generating element by motion of the moving object;
releasing the separator to permit sudden expansion of the force-generating element and upward or return motion of the platform;
driving an output device connected to a moving component of the system, including the moving object or a spring platform, to generate mechanical work or electric power;
repeating the cycle by allowing the platform to return under gravity, spring rebound, or magnetic repulsion to the compression position; and
resetting the separator using energy stored or harvested from prior motion or via external input including electronic, magnetic, or mechanical actuation to enable continuous or controlled repetition.

19. The method of claim 18, wherein the separator is released using stored mechanical energy, a motion-triggered latch, or electromagnetic actuation without requiring continuous external power.

20. The system of claim 1, wherein the moving object is configured to return to its compression position following energy release via gravitational descent, magnetic repulsion, spring recoil, or a combination thereof, enabling continuous cyclical operation.
